(19) United States
(12) Patent Application Publication
(10) Pub. No.: US 2022/0013242 A1
(43) Pub. Date: Jan. 13, 2022

(54) DUAL FLUID REACTOR - VARIANT WITH LIQUID METAL FISSIONABLE MATERIAL (DFR/M)

(71) Applicant: Armin HUKE, Berlin (DE)

(72) Inventors: Armin HUKE, Berlin (DE); Stephan GOTTLIEB, Herdecke (DE); Daniel WEISSBACH, Berlin (DE); Götz RUPRECHT, Berlin (DE); Konrad CZERSKI, Berlin (DE)

(73) Assignee: Armin HUKE, Berlin (DE)

(21) Appl. No.: 17/290,358

(22) PCT Filed: Nov. 1, 2019
(86) PCT No.: PCT/DE2019/000288

§ 371 Date: Apr. 30, 2021

(30) Foreign Application Priority Data
Nov. 1, 2018 (DE) 10 2018 008 541.5

(51) Int. Cl. G21C 1/02; G21C 3/52

(52) U.S. Cl. CPC G21C 1/02; G21C 3/52

(57) ABSTRACT

The invention relates to a nuclear reactor operating according to the dual fluid principle with a special liquid metal fissionable mixture as liquid fuel in the liquid fuel line, which has a high percentage of actinoids, preferably 69% and higher. Preferred metals are selected from chromium (Cr), manganese (Mn) and iron (Fe). Preferred actinoids are selected from thorium (Th), uranium (U) and plutonium (Pu). The mixtures and resulting multicomponent alloys need not necessarily be an eutectic.

### DESCRIPTION OF THE INVENTION

The invention relates to a nuclear reactor operating according to the dual fluid principle with a special liquid metal fissionable material mixture as liquid fuel in the liquid fuel line.

### PRIOR ART

A dual fluid reactor (DFR), known from EP 2 758 965 B1, is a new type of nuclear high-temperature reactor with a fast neutron spectrum, which, unlike all other reactor concepts for power plants, operates with two separate fluid loops. These two fluid loops include a primary coolant loop consisting of a liquid metal for highly efficient removal of the high power density of nuclear fission reactions and a liquid fissionable material loop for optimal utilization and processing of the fissionable material, with heat transfer from the liquid fissionable material to the coolant via a piping system within the fission zone in the reactor core. This results in a highly efficient, inherently passively safe, adiabatic power plant reactor with an energy return on energy invested factor over an order of magnitude higher than for previous nuclear power plant types. The composition of the liquid fissionable material is not specified. Two variants are possible: A liquid salt melt or a liquid metal mixture.

In the case of the liquid salt melt, the optimum composition consists of actinide trichlorides. Due to the high heat transport capacity of the liquid metal coolant, it is possible to remove the high heat output of the nuclear chain reaction from the reactor core. Dilution of the actinide salts is not required. This distinguishes the DFR from the well-known molten salt reactor (MSR), where the molten salt provides both the fissionable material and the heat transport and must therefore necessarily be diluted. Therefore, only salt eutectics with low actinide concentration are considered for the MSR, resulting in lower power density and increased corrosion problems.

However, even the undiluted actinoid trichloride has disadvantages. The stoichiometry of 1:3 already represents a dilution of the actinoid concentration, which results in a reduction of neutron economy; also due to the moderation effect of the relatively light chlorine. Another significant drawback is the low thermal conductivity of the salt, which has a particular effect on heat transfer to the cladding tubes, but also on intrasalt heat distribution. This must be countered by pumping the molten salt through the reactor core at a rate that ensures that turbulence occurs in the fluid. This also limits the power density. Furthermore, continuous processing of the fissionable material to remove the fission products is significantly impeded.

When a liquid metal mixture is used as the fissionable material fluid, the problem of thermal conductivity is solved directly, as already stated in EP 2758 965 B1. The fissionable material no longer has to be pumped and the power density can be increased, the working temperature as well. However, the design of a suitable liquid metal mixture is difficult.

Uranium and even more thorium have too high melting points for power plant operation. Therefore, a reduction of at least the solidus temperature by admixture of other metals with sufficiently favorable neutron properties is required. The resulting multicomponent alloy need not necessarily be an eutectic. Even if the liquidus temperature is above the operating temperature, the mixture is sufficiently pumpable in this mushy phase.

The use of liquid metal mixtures as fissionable materials has been the subject of research in the past. Lead and, in particular, bismuth with their low melting points were relied upon. The actinoids should be dissolved, which results in a very low actinoid concentration with the corresponding disadvantages, more pronounced than with molten salts. This could reduce the neutron economy and with it the transmutation power of such a reactor.

Safety research on special solid fission reactors pointed another way: In previous nuclear reactor types, the use of solid metallic fission material was already considered in the early days (Generation I) and corresponding tests were carried out. During operation of fuel assemblies with metallic fissionable material, it was found that it warps during burnup, forming cavities and cracks. This in turn reduces heat transfer and leads to deformation of cladding tubes. Therefore, it was switched to using ceramic oxide fissionable material pallets, despite their low thermal conductivity. For the Integral Fast Reactor (IFR) in the USA, metallic fissionable material was then to be used again. There, the problems were solved by using a smaller volume of fissionable material than was present in the cladding tubes. The cavities thus already present were filled with liquid sodium.

Regardless of the specific fissionable material mixture, investigations were carried out for accident scenarios where the fissionable material overheated and its effects on the cladding tube materials became apparent. For the case of a metallic fissionable material, this may result in its melting. How the molten fissionable material then attacks the cladding tube materials was therefore also the subject of the investigations. The liquefying uranium begins to dissolve the cladding tubes—usually made of stainless steel alloys in fast reactors—with varying degrees of dissolution of the steel alloy elements. Closer examination of these dissolution characteristics and resulting metal mixtures led to the characterization of eutectic mixtures of uranium and thorium with chemical elements from stainless steel. As a basis for liquid metal fission mixtures for a reactor such as the DFR, these are the binary eutectics: 1. uranium/chromium (80 atom-% U, 20 atom-% Cr) 2. uranium/manganese (80 atom-% U, 20 atom-% Mn) 3. thorium/iron (70 atom-% Th, 30 atom-% Fe).

However, the use of these eutectics in liquid fission reactors was never envisaged and has not been considered so far. This is because this issue has never arisen, since the only variant of a liquid fission reactor to date has been the MSR mentioned above. With the invention of the DFR, the situation changes fundamentally, since metallic liquid fissionable material can also be considered here.

### OBJECTIVE AND TASK OF THE INVENTION

As stated above, the composition of a suitable liquid metal fissionable material mixture is difficult to find. Thus, the task of the invention is to provide a liquid metal fissionable material for dual fluid reactors, which is characterized by high thermal conductivity, high actinide nuclide density, high power density and a high working temperature, allows continuous discharge in a dual fluid reactor and can thus be used as fuel in the fuel line of a dual fluid reactor.

### Essence of the Invention

The problem is solved by using a molten metal mixture based on a predominant proportion of actinoids, in particular actinoid eutectics, for various operating modes and breeding cycles in a DFR, as further described.

It has been found that multicomponent alloys or resulting multicomponent alloys need not necessarily be an eutectic.

The basis of the invention is research conducted for accident scenarios where the fissionable material overheated and its effects on cladding materials became apparent. For the case of a metallic fissile material, this can result in its melting. The disadvantage is that, for example, liquefying uranium begins to dissolve the cladding tubes—usually made of stainless steel alloys in fast reactors—with varying degrees of dissolution of the steel alloy elements.

According to the invention, on the basis of these dissolution properties, metal mixtures could be found which are suitable advantageous, partly eutectic, mixtures, preferably of thorium, uranium and plutonium with chemical elements of steels such as iron, chromium or manganese.

The use of eutectics in liquid fission reactors has not been considered so far, since the only variant of a liquid fission reactor to date is the MSR mentioned above. However, the present invention allows the use of actinoid eutectics and multicomponent alloys with a high actinoid content as liquid metal fissionable mixtures in a dual fluid reactor (DFR).

Dual fluid reactors are known (cf. EP 2 758 965 B1) and are characterized for example by a first conduit for continuously feeding and discharging a liquid fuel into a core volume in a reactor core vessel, said first conduit entering the reactor core vessel via an inlet, being guided through the core volume and leaving the reactor core vessel via an outlet, wherein the chain reaction can proceed critically or subcritically, and a second conduit for a liquid coolant, which is arranged such that the coolant from the second conduit enters said reactor core vessel via an inlet, runs around the first conduit and leaves the reactor core vessel again through an outlet.

Accordingly, it is an object of the invention to provide a dual fluid reactor (DFR) comprising liquid mixtures of metals having a high actinide content as liquid fuel in the liquid fuel line.

Preferably, the proportion of non-actinoid metals in the mixture is at most 31 atom-% and the proportion of actinoids is at least 69 atom-%. A deviation of at most 1% is possible.

In one embodiment of the invention, the metals are selected from chromium (Cr), manganese (Mn) and/or iron (Fe). Preferred actinoids are selected from thorium (Th), uranium (U) and/or plutonium (Pu).

Thorium is preferably used as Th-232, and optionally portions of other isotopes if spent fuel is used, uranium preferably as U-233, U-235, U-238, and optionally portions of other isotopes such as U-236 if spent fuel is used, and plutonium preferably as Pu-239, Pu-240, Pu-241, Pu-242, and optionally portions of other isotopes if spent fuel is used, in the initial charge of the core. In addition, if spent fuel is used, up to 3 atom-% fission products may be contained in the initial charge and portions of the fissile and fissionable materials may be substituted by nuclides of transuranics.

In a preferred embodiment of the invention, the following binary eutectics serve as the basis for liquid metal fission mixtures for such a dual fluid reactor:

1 uranium/chromium
(preferably in a ratio of 4:1, i.e. preferably approx. 80 atom-% U, approx. 20 atom-% Cr),

2 uranium/manganese
(preferably in the ratio 4:1, i.e. preferably-approx. 80 atom-% U, approx. 20 atom-% Mn) and/or

3 thorium/iron
(preferably in the ratio 7:3, i.e. preferably approx. 70 atom-% Th, approx. 30 atom-% Fe)

Although the above-mentioned binary eutectics have not yet been considered as liquid metal fissionable mixtures for nuclear power plants, they are particularly suitable for use in the DFR. They are characterized by a very high actinide concentration, which optimizes the neutron economy and thus the transmutation capability of the reactor. Their melting point is 800° C., which qualifies them for operation. The boiling points are well above 2000° C., so that the operating temperature can also be increased, since steam bubbling is far away, corresponding to the lead coolant. The high thermal conductivity makes continuous pumping of the fission fluid obsolete. Overall, this leads to an increase in power density and thus also to higher power plant efficiency.

In the purely binary alloy form, they cannot be used in the fast fission reactor, nor do they remain in this form due to the transmutation that continues during operation. Any critical nuclear reactor requires a sufficiently high concentration of fissile materials, i.e. nuclides that are also fissile at thermal and epithermal neutron energies (i.e. U-U-235, Pu-239, Pu-241, i.e. mainly nuclides with odd neutron number), and not like the fissionable materials only at high neutron energies (Th-232, U-238, also transuranium nuclides with even neutron number). Thorium is not critically fissile in any reactor, and natural uranium is not critically fissile in any reactor with a fast neutron spectrum. The concentration of fissile materials must be significantly increased for fast fission reactors. Both of these factors mean that a binary alloy will not be maintained, and probably the condition of a eutectic will not be met, i.e., coincidence of the solidus and liquidus temperatures. The resulting fission products could initially be completely dissolved in the alloy due to the low mass turnover of nuclear fission. However, the outstanding neutron economy of such a DFR allows such long operating times without reprocessing of the fissionable mixture that here, too, the concentration can increase to such an extent that agglomeration effects occur. In addition, the actinide nuclides also change due to sterile neutron capture and beta decay; in addition to new uranium and plutonium, protactinium, neptunium and americium are produced, for example. This results in mixtures that differ significantly in quality and quantity from binary eutectics. The mixtures with more than 2 components and in particular increased fission product concentration may deviate in the parameter range from the values for eutectics, but as long as the solidus temperature and the total viscosity are low enough for pumping, this does not affect the operability.

In accordance with the invention, the following preferred variants of a metal mixture are used as a fresh inventory for a DFR reactor core:

1 Enriched U/Cr, U/Mn and/or Th/Fe as binary eutectic. Particularly preferred are
uranium/chromium as [79, 81] atom-% U, [19, 21] atom-% Cr, uranium/manganese as [79, 81] atom-% U, [19, 21] atom-% Mn and/or thorium/iron as [69, 71] atom-% Th, [29, 31] atom-% Fe. Most preferably, a binary eutectic consisting of [7, 12] atom-% U-235, [67, 74] atom-% U-238, [19, 21] atom-% {Cr or Mn} is used initially. Conversion during operation successively replaces the U-235 fraction with plutonium, predominantly Pu-239, producing a ternary mixture plus fission products.

2A ternary mixture of Pu/U/Cr. Particularly preferred is initially a ternary mixture
consisting of [7, 12] atom-% Pu-239, [67, 74] atom-% U-238, [19, 21] atom-% {Cr or Mn}. The Pu content remains approximately constant by conversion of U-238. U-238 is consumed and replaced by fission products.

3A quaternary mixture of U/Th/Fe/Cr. Particularly preferably, a quaternary mixture
consisting of [7, 12] atom-% U-233, [1, 4] atom-% {Cr or Mn}, [59, 64] atom-% Th-232, and [25, 29] atom-% Fe is used initially. U-233 is necessary here as the only fissile material. Thorium is only fertile material for consumption for conversion to U-233. A mixture of Fe and Cr should achieve the eutectic condition for the quaternary mixture.

4A quaternary mixture of Pu/Th/Fe/Cr. This quaternary mixture acts as the starting
inventory for the thorium cycle for U-233 burning. Since plutonium is much more readily available than U-233, it is particularly preferred to initially use a mixture consisting of [7, 12] atom-% Pu, [1, 4] atom-% {Cr or Mn}, [59, 64] atom-% Th-232, and [25, 29] atom-% Fe. Transitionally, the pentary mixture U/Pu/Th/Fe/Cr towards U/Th/Fe/Cr is formed.

5A pentary mixture of U/Pu/Th/Fe/Cr. This pentary mixture is suitable for hybrid
operation, exploiting the very high neutron yield of plutonium, for maximized breeding of U-233 from thorium alongside regeneration of plutonium from U-238. Conversely, the thorium/U-238 fraction, can be adjusted to minimize the conversion rate for burner/incinerator operation. For this purpose, neutron-physically largely inert materials can also be added to dilute the fissile material, e.g. Zr, Al or Mg. Component proportions also result from burnup optimization.

The percentages of the substances in the mixtures to be used always add up to 100%.

The invention will be further explained in detail below by way of example:

Neutron physics simulations of a IFR operated with liquid metal fuel showed that the concentration of fissile material to meet the criticality condition must be ˜10 atom-% depending on the nominal power of the reactor core. For a 600 MWth SMR core this is ˜11 atom-%, for the common power plant size of 3000 MWth it is ˜9 atom-%, and for a 30000 MWth refinery process heat plant it is ˜8 atom-%. The concentration differences of the various fissile nuclides are in the per mil range, with plutonium being the lower limit, because of the largest neutron yield in the fast spectrum. Chromium, as an alloying component, has the advantage over manganese in combination with uranium of absorbing fewer neutrons, although the difference is not a criterion for exclusion. In addition to Cr, Mn can also be used, The use of Mn requires an increase in the concentration of strong fissile material to compensate. In addition, the simulations show that the neutron spectrum is very hard; and as a result, several nuclides with even neutron numbers become burnable, i. e., k_{inf}>1. These are the nuclides U-234, Pu-240, and Pu-242, which are significant for practical operation. As a result, the conversion rate of the reactor jumps, since the creation of said nuclides no longer represents sterile neutron capture. For the U/Pu cycle, for example, this means an increase from 1.3 to 2.1. As a result, the incineration of the transuranium elements from the spent fuel elements of the previous nuclear power plants, which constitute the waste problem to be disposed of geologically, also becomes possible with maximum efficiency.

This results in an interval of [7, 12] atom-% for the concentration of fissile materials. On the other hand, the proportion of alloying components {Cr or Mn} 20 atom-% and Fe 30 atom-% to reach the eutectic condition is clearly fixed and varies at 1%. The complement to 100% is replenished by the fissionable or fertile material (uranium-238 in natural uranium or depleted uranium or reprocessed uranium together with U-236, thorium-232).

Based on the above simple eutectics with addition of fissile nuclides and various fertile nuclides, there are several operating possibilities of the DFR with various fissionable material combinations, which includes mixed and transition modes. The simplest transition mode of operation is starting with lightly enriched uranium (LEU). The alloy addition is {Cr or Mn} with a constant proportion. As it progresses, the plutonium fraction increases due to consumption of the fertile U-238, eventually replacing U-235 as a fissile material, adding fission products as above.

The use of thorium as fertile material implies mixed operation from the outset. Thorium requires 30 atom-% iron (variation at 1%) as an alloying component for the eutectic condition (Fe/Th= 3/7), while the fissile U-233 produced in the breeding process requires 20 atom-% chromium as an alloying component (Cr/U=¼). Together with the condition that all constituents must add up to 100%, this results in a linear system of equations for the stoichiometric calculation with the 3 unknowns of the alloy constituents and thorium, where the proportion of fissile material is given by the reactor power (the variables can be intervals), with the respective proportions as the solution.

In practice, U-233 is hardly available as a result of the thorium breeding cycle, so to start a reactor with thorium as fertile material, it is also envisaged to use plutonium as fissile material from the commercial PUREX reprocessing plants. Plutonium is so similar to uranium in its relevant chemical properties that {Cr or Mn} is also used as an alloying component to achieve the eutectic condition.

Therefore, uranium and plutonium add up in the stoichiometric calculation (Cr/(U+Pu)=¼). This also represents a transition mode in which plutonium is successively replaced by U-233 while thorium is consumed. Another very long-term transition mode to the thorium cycle results as a variation of reactor startup with LEU. The fertile material U-238, which is consumed while breeding Pu-239, is replaced by Th-232 rather than U-238 during the fuel processing cycles in the PPU (pyrochemical processing unit) of the UFR.

For maximized breeding of U-233 for other uses, such as in mobile thermal reactors as the sole fissile material or for contamination of HEU (highly enriched uranium) as a proliferation countermeasure, hybrid operation can also be performed in conjunction with the PPU, in which plutonium with its high neutron yield provides the breeding excess neutrons for thorium capture. This involves adding enough U-238 to regenerate the spent plutonium. Frequent processing of the fuel fluid in the PPU allows the intermediate nuclide Pa-233 to be sequestered so that U-233 is produced primarily outside the reactor core rather than being fissioned in the reactor. The composition is a neutron physics optimization problem. The fraction of {Cr, Mn} is obtained as one fourth of the added fraction of Pu and U. The necessary fraction of Fe is 3/7 of Th.

For the incineration of transuranics from irradiated fuel elements of nuclear power plants, they can usually be added to the fertile material as fissionable materials. Depending on the amount of the fraction and chemical properties, the {Cr, Mn} and Fe fractions are adjusted. If operation as a burner/incinerator is desired, i.e. to avoid excess breeding, the fertile material can be diluted by neutron-physically inert nuclides (i.e. low neutron absorption cross-section and no formation of long-lived radioactive nuclides), e.g. with Zr, Ma or Al.

1. Dual fluid reactor (DFR), wherein it has a liquid fuel in the liquid fuel line comprising liquid mixtures of metals with a predominant actinide content as a liquid metal fissionable mixture.

2. Reactor according to claim 1, wherein the content of actinoids is at least 69 atom-% and higher.

3. Reactor according to claim 1, wherein the additional non-actinoid metals are selected from chromium (Cr), manganese (Mn) and/or iron (Fe).

4. Reactor according to claim 1, wherein the liquid metal fissionable mixture as fresh inventory in the reactor core consists of the binary eutectics uranium/chromium or uranium/manganese, preferably in the molar ratio 4:1, and/or thorium/iron, preferably in the ratio 7:3.

5. Reactor according to claim 4, wherein the liquid metal fissionable mixture initially consists of the binary eutectic uranium/chromium as [79, 81] atom-% U, [19, 21] atom-% Cr, uranium/manganese [79, 81] atom-% U, [19, 21] atom-% Mn and/or [69, 71] atom-% Th, [29, 31] atom-% Fe, preferably of [7, 12] atom-% U-235, [67, 74] atom-% U-238, [19, 21] atom-% {Cr or Mn}, whereby with corresponding proportional reduction of the aforementioned proportions, while maintaining their composition ratio, up to 3 (three) atom-% fission product elements can be contained and the percentages always add up to 100%.

6. Reactor according to claim 1, wherein the liquid metal fissionable mixture as fresh inventory in the reactor core is a ternary mixture of plutonium/uranium/chromium or plutonium/uranium/manganese, preferably a ternary mixture consisting of [7, 12] atom-% Pu-239, [67, 74] atom-% U-238, [19, 21] atom-% {Cr or Mn} where, with corresponding proportional reduction of the above proportions while maintaining their compositional ratio, up to 3 (three) atom-% fission product elements may be present and the percentages always add up to 100%.

7. Reactor according to claim 1, wherein the liquid metal fissionable mixture as fresh inventory in the reactor core is a quaternary mixture of uranium/thorium/iron/chromium or uranium/thorium/iron/manganese, preferably a quaternary mixture consisting of [7, 12] atom-% U-233, [1, 4] atom-% {Cr or Mn}, [59, 64] atom-% Th and [25, 29] atom-% Fe, whereby, with corresponding proportional reduction of the aforementioned proportions while maintaining their composition ratio, up to 3 (three) atom-% fission product elements may be contained and the percentages always add up to 100%.

8. Reactor according to claim 1, wherein the liquid metal fissionable mixture as fresh inventory in the reactor core is a quaternary mixture of plutonium/thorium/iron/chromium or plutonium/thorium/iron/manganese, preferably a quaternary mixture consisting of [7, 12] atom-% Pu, [1, 4] atom-% {Cr or Mn}, [59, 64] atom-% Th-232 and [25, 29] atom-% Fe, whereby, with corresponding proportional reduction of the aforementioned proportions while maintaining their composition ratio, up to 3 (three) atom-% fission product elements may be contained and the percentages always add up to 100%.

9. Reactor according to claim 1, wherein the liquid metal fissionable mixture as fresh inventory in the reactor core is a pentary mixture of uranium/plutonium/thorium/iron/chromium or uranium/plutonium/thorium/iron/manganese, preferably a pentary mixture consisting of U/Pu/Th/Fe/{Cr or Mn} with an upper limit of 20 atom-% {Cr or Mn} and 30 atom-% Fe with variable proportions of U and Pu and Th with the boundary conditions {Cr or Mn}=¼(U and Pu) and Fe= 3/7 Th, whereby, with corresponding proportional reduction of the above-mentioned proportions while maintaining their composition ratio, up to 3 (three) atom-% fission product elements can be contained and the percentages always add up to 100%.

10. Reactor according to claim 1, wherein the liquid metal fissionable mixture contains as fresh inventory in the reactor core a binary eutectic consisting of [7, 12] atom-% U-235, [67, 74] atom-% U-238, [19, 21] atom-% {Cr or Mn}, with the percentages always adding up to 100%, and with an eventual transition to a pentary mixture consisting of U/Pu/Th/Fe/{Cr or Mn} as recycled inventory, with the long-term transition to a quaternary mixture consisting of [7, 12] atom-% U-233, [1, 4] atom-% {Cr or Mn}, [59, 64] atom-% Th and [25, 29] atom-% Fe, wherein, with corresponding proportional reduction of the aforementioned proportions while maintaining their composition ratio, up to 3 (three) atom-% fission product elements can be contained and the percentages always add up to 100%.
